(19) United States
(12) Patent Application Publication
(10) Pub. No.: US 2018/0293646 A1
(43) Pub. Date: Oct. 11, 2018

(54) Inspiration Feedback by an Activity Assistant

(71) Applicants: Stephen Chau, Palo Alto, CA (US); Andrew T. Szybalski, San Francisco, CA (US); Stephane Lafon, Sunnyvale, CA (US); Andrea Lynn Frome, Berkeley, CA (US); Jerry Howard Morrison, Mountain View, CA (US); Derek Prothro, San Mateo, CA (US); Huy Nguyen, San Jose, CA (US)

(72) Inventors: Stephen Chau, Palo Alto, CA (US); Andrew T. Szybalski, San Francisco, CA (US); Stephane Lafon, Sunnyvale, CA (US); Andrea Lynn Frome, Berkeley, CA (US); Jerry Howard Morrison, Mountain View, CA (US); Derek Prothro, San Mateo, CA (US); Huy Nguyen, San Jose, CA (US)

(73) Assignee: Google Inc., Mountain View, CA (US)

(21) Appl. No.: 13/333,984

(22) Filed: Dec. 21, 2011

Related U.S. Application Data
(60) Provisional application No. 61/425,719, filed on Dec. 21, 2010.

(51) Int. Cl. G06Q 40/02; G06Q 10/10

(52) U.S. Cl. CPC G06Q 40/02; G06Q 10/10

(57) ABSTRACT

For each of one or more users of an activity assistant, the subject technology maintains an account record in a user-account database for the user's account. The account record includes an activity list that includes one or more activities associated with the user's account. The subject technology provides an activity-assistant GUI that is accessible to an accessing user via the accessing user's account. The GUI includes one or more UI elements that each identify an activity that is: (a) linked to another one of the users' accounts, and (b) addable by the accessing user via interaction with the UI element. For at least one of the users, the subject technology receives an indication whenever another one of the users adds one of the activities that is linked to the given user's account via interaction with the UI element that identifies the activity as linked to the given user's account.

### CROSS-REFERENCE TO RELATED APPLICATIONS

The present application claims the benefit of priority under 35 U.S.C. § 119 from U.S. Provisional Patent Application Ser. No. 61/425,719 entitled “INSPIRATION FEEDBACK BY AN ACTIVITY ASSISTANT,” filed on Dec. 21, 2010, the disclosure of which is hereby incorporated by reference in its entirety for all purposes.

### BACKGROUND

Unless otherwise indicated herein, the materials described in this section are not admitted to be prior art by inclusion in this section.

Various technologies can be utilized to electronically exchange information between users. For example, computers, telephones, and personal digital assistants (PDAs) can be used to exchange content over communication networks including the Internet. The content exchanged between such devices can include web pages that, in turn, can include text, video data, audio data and/or other types of data.

### SUMMARY

Disclosed herein are methods and systems that relate to an “activity assistant” that provides users with dynamically-selected “activities” that are intelligently tailored to the user's world. Accordingly, an example activity assistant may customize display of a user's activity list, suggest activities, and customize activity search results based on personalized factors such as the user's interests, current mood, and intent. Furthermore, an example activity assistant may also be capable of intelligently varying the behavior of a given activity from one user to another, depending upon the characteristics of a given user. For example, the activity assistant may score an activity based not only on the characteristics of the activity itself, but also based on data that is indicative of the user's “context” (e.g., the user's, interests, intents, moods, experiences, etc.).

According to an example embodiment, a user interface may also be provided that allows for intuitive user interaction with activities via the activity assistant. This user interface may be generally referred to herein as an “activity assistant user interface”. A user typically accesses the activity assistant UI by logging in to a user's activity-assistant account. According to an example embodiment, the activity assistant UI displays graphical representations of activities to a user in a logical manner that varies according to the interests, intents, and moods of the user. Via the activity assistant UI, the user may view activities they have added to a personal “activity list,” view suggested activities, create and add new activities to their activity list, and/or add/delete existing activities (i.e. those created by other users) to/from their activity list, among other functions.

In one aspect, an example method performed by a computing device may involve: (i) for each of one or more users of an activity assistant, maintaining an account record in a user-account database for the user's account, wherein the account record comprises an activity list comprising one or more activities associated with the user's account, (ii) providing an activity-assistant GUI that is accessible to an accessing user via the accessing user's account, wherein the GUI comprises one or more UI elements that each identify an activity that is: (a) linked to another one of the users' accounts, and (b) addable by the accessing user via interaction with the UI element; and (iii) for at least a given one of the users: (a) detecting any instance where another one of the users adds one of the activities that is linked to the given user's account via interaction with the UI element that identifies the activity as linked to the given user's account; (b) detecting any instance where another one of the users interacts with a UI element indicating that the other user has completed the previously-added activity linked to the given user's account; and (c) storing data in the account record for the given user's account, wherein the data indicates: (a) how many other users have added the activity, and (b) of the users that have added the activity, how many have completed the activity.

The example method may further involve, in any instance where it is detected that another one of the users has added one of the activities that is linked to a given user's account, updating an activity parameter (which may be displayed via a screen of the GUI) to include an indication that the other user has added the activity. Additionally or alternatively, when it is detected that another one of the users has added one of the activities that is linked to a given user's account, the given user may be sent a notification that this has occurred. Similarly, in any instance where it is detected that another user has completed a previously-added activity that is linked to a given user's account, the activity assistant may: (a) update or set an activity parameter (which may be displayed to the given user via a screen of the GUI) to indicate that the other user has added the activity, and/or (b) send a notification to the given user may be sent a notification that this has occurred.

### BRIEF DESCRIPTION OF THE FIGURES

FIG. 1 depicts a network in accordance with an example embodiment.

FIG. 2A is a block diagram of a computing device in accordance with an example embodiment.

FIG. 2B depicts a network with computing clusters in accordance with an example embodiment.

FIG. 3A is a block diagram illustrating features of a user interface, according to an example embodiment.

FIG. 3B is another block diagram illustrating features of a user interface, according to an example embodiment.

FIG. 4A is an illustration of a UI to add an activity, according to an example embodiment.

FIG. 4B is an illustration of a UI including activity detail, according to an example embodiment.

FIG. 4C is an illustration of a UI displaying a list of a user's most “inspirational” activities, according to an example embodiment.

FIG. 5 is an illustration of a UI displaying a list of users that are directly and indirectly inspired to add an activity, according to an example embodiment.

FIG. 6 is flow chart illustrating a method according to an example embodiment.

### DETAILED DESCRIPTION

The following detailed description describes various features and functions of the example systems, devices, and methods with reference to the accompanying figures. It should be understood that the word “example” is used herein to mean “serving as an example, instance, or illustration.” Any embodiment described herein as “example” is not necessarily to be construed as preferred or advantageous over other embodiments. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

An “activity”, as used herein, can be a data construct describing a thing to do, which a user can associate with a user's “activity-assistant account.” In an example embodiment, an activity is defined at least in part by one or more singular, global activity parameters. For example, global parameters for a given activity may include: (a) a title or text description (e.g., “get brunch at Boogaloo's restaurant”), (b) data indicating the location that is associated with the activity (e.g., the latitude/longitude and/or the address of Boogaloo's restaurant), (c) data indicating one or more user “moods” that may be indicative of the activity being more or less well-suited for a given user (e.g., “fun”, “social”, “cerebral”, “productive”, “ambitious”, etc.), (d) data indicating time constraints on the activity (e.g., the hours Boogaloo's restaurant is open and/or the hours during which Boogaloo's restaurant serves brunch), and (e) any other data that may be directly or indirectly interpreted to affect the importance of a given activity to a given user.

Generally, an activity is a user-defined construct, and thus the global parameters that define each activity may vary. In particular, a given activity may or may not include all of the above-mentioned global activity parameters. For example, a user may create an activity that is not tied to any particular location (e.g., “do homework for math class”), and thus choose not to provide a location. Furthermore, as activities are flexible and dynamic constructs, it should be understood that the above-mentioned examples of global parameters are not limiting. It is also possible that an activity may be generated by a computing system without any initial user input (or alternatively, generated based on some user-provided input).

Once an activity is created, however, its global parameters apply to all users who add the activity. Thus, in effect, there is a single copy of each activity and its global parameters that is common all users that have access to the activity. It should be understood, however, that global parameters can still be flexible and dynamic; changing over time in relation to the activity. For example, a “popularity” parameter may be defined for an activity that is updated on an ongoing basis to reflect the number of users that have added the activity.

To further allow for customization of activities to a particular user, “user-specific” parameters, which vary between users, may be defined for an activity. Accordingly, while the global parameters of an activity are the same for all users, each user that adds an activity may customize their user-specific parameters for the activity. For instance, user-specific parameters may be used to specify: (a) plans regarding the activity (e.g., “I want to do it”, “I want to do it again, but not for a few weeks,” “I must do it before December 25,” “I never want to do it again,” etc.), (b) the user's history regarding that scheme (e.g., I went there with Lauren on November 4 and again with Ryan on November 28), (c) personal time constraints based on user preferences (e.g., preference of brunch early on Sunday so she has time to digest before her yoga class at noon or preference of brunch around noon because he usually stays out late on the weekends), and/or (d) any other personal preferences related to, and “overrides” or modifications of, the global parameters (e.g., “I like to go to Boogaloo's restaurant when I'm depressed because it cheers me up,” “I like to go to Boogaloo's restaurant when I have friends in town,” etc.).

In a further aspect, an activity may be designated as a “public” or “private” activity. Depending on how a given activity is defined, this designation may be made by setting a global parameter when the activity is created (and thus apply to all users who add the activity), and/or may be made via a user-specific parameter that is settable by each user who adds an activity.

An activity that is designated as “public” via a global parameter may be viewable (and thus addable) to all users, whereas an activity that is designated as “private” via a global parameter may only be viewable to the creator of the activity. In an example embodiment, a global parameter may be set to designate an activity as a “private shared” activity, in which case the activity may only be viewable by the author and the users the author specifies. Further, the fact that a given activity is designated as “public,” “private,” or “private shared” via a global parameter may be interpreted as a signal relevant to the importance of the activity to a certain user.

When an activity is designated as “private” via a user-specific parameter, other users are generally not notified that the user has added the activity. And when an activity is designated as “public” via a user-specific parameter, other users may be notified and/or be able to see that the user has added the activity. Further, when an activity is designated as “public” via a user-specific parameter, the user may be able to define which other users can view and/or which other users should be notified that they have added the activity.

In an example embodiment, an “activity assistant” is provided, which is configured to evaluate the relative importance of activities to a particular user so that activities can be presented on the activity assistant user interface in a logical manner. In particular, the activity assistant may score an activity based not only on the characteristics of the activity itself, but also based on data that is indicative of the user's “context” (e.g., the user's, interests, intents, moods, experiences, associations with other users, etc.). With the support of the activity assistant, the activity assistant user interface may therefore provide users with a dynamic and flexible mechanism for deciding what activities they might enjoy, and how they would like to spend their time.

In order to quantify the importance of a particular activity for a particular user, the activity assistant may identify and/or determine any number of “signals” that may be directly or indirectly relevant to the importance of an activity to the particular user. From the perspective of the activity assistant, signals may take the form of information provided by global parameters and user-specific parameters taken individually or information determined by evaluating interactions between global parameters, user-specific parameters, and/or other data sources. The activity assistant may evaluate the signals for a particular user in combination with a particular activity, the activity assistant may quantify the importance of the particular activity for the particular user (e.g., by assigning a “score” to the activity).

To provide some examples of such signals, they may include but are not limited to: (a) the level of similarity between user's mood and activity mood, (b) the level of similarity between the user's context (as indicated by user-specific signals and/or user-specific parameters indicating, for example, whether the user is on a desktop computer/mobile phone, on-line/off-line, talking on the phone, driving, walking, etc.) and corresponding activity context requirements and/or restrictions (as indicated by global parameters of the activity), (c) distance between user's location and activity location (if available), (d) appropriateness of current weather at user's location and/or activity's location for the activity (e.g., rainy, sunny, snowy, etc.), (e) user-designated priority for the activity, (f) user-designated due date (or next due date, if recurring), (f) snooze history or pattern for the activity, (g) amount of time required for the activity, (h) progress or status of the activity (done, active, in-progress, etc.), (i) ownership of the activity (e.g., whether the owner is the particular user in question or another user), (j) whether the user received a heads-up, (k) popularity of the activity (e.g., number of comments on an activity, or the number of people who have commented, copied, liked, shared, done, or followed the activity), (l) similarity between user query string and activity text (for search/suggest), (m) similarity between user query string and names or e-mails of other users in the activity (for search/suggest), (n) similarity between user query string and activity comment text (for search/suggest), and (o) whether the user indicated another user with whom to participate in the activity with.

Supported with this intelligence from the activity assistant, the activity assistant user interface may present activities that a particular user has associated with their account in a logical order that is based at least in part upon the relative importance of the activities to the user. In particular, the activity assistant may evaluate the signals for each activity in a user's activity list (e.g., each activity that has been added by the user) and assign a score to the activity. The activity assistant can then rank the activities in the user's activity list according to their respectively determined score, and relay this information to the activity assistant user interface so that it can adjust the displayed activity list accordingly.

Further, the intelligence of the activity assistant may be utilized to provide “suggested” activities that are tailored to the particular user's preferences, tendencies, location, time table, associated other users, and/or mood at a given point in time. In particular, the activity assistant may initiate an activity search that takes into account the scores of activities when ranking the search results, and these search results may be presented to the user via the activity assistant user interface. In a similar manner, the activity assistant may support an “activity search” feature of the activity assistant user interface. This feature may allow the user to enter text and initiate an activity search on the text, the results of which factor in the relative scores of activities as assessed by the activity assistant.

According to an example embodiment, a user interface is provided that allows for intuitive user interaction with such activities. This user interface may be generally referred to herein as an “activity assistant user interface”. A user typically accesses the activity assistant user interface by logging in to a user's activity-assistant account. According to an example embodiment, the activity assistant user interface displays graphical representations of activities to a user in a logical manner that varies according to the interests, intents, associations with other users, and moods of the user. Via the activity assistant user interface, the user may view activities they have added to a personal “activity list,” view suggested activities, create and add new activities to their activity list, and/or add/delete existing activities (e.g., those created by other users) to/from their activity list, among other functions.

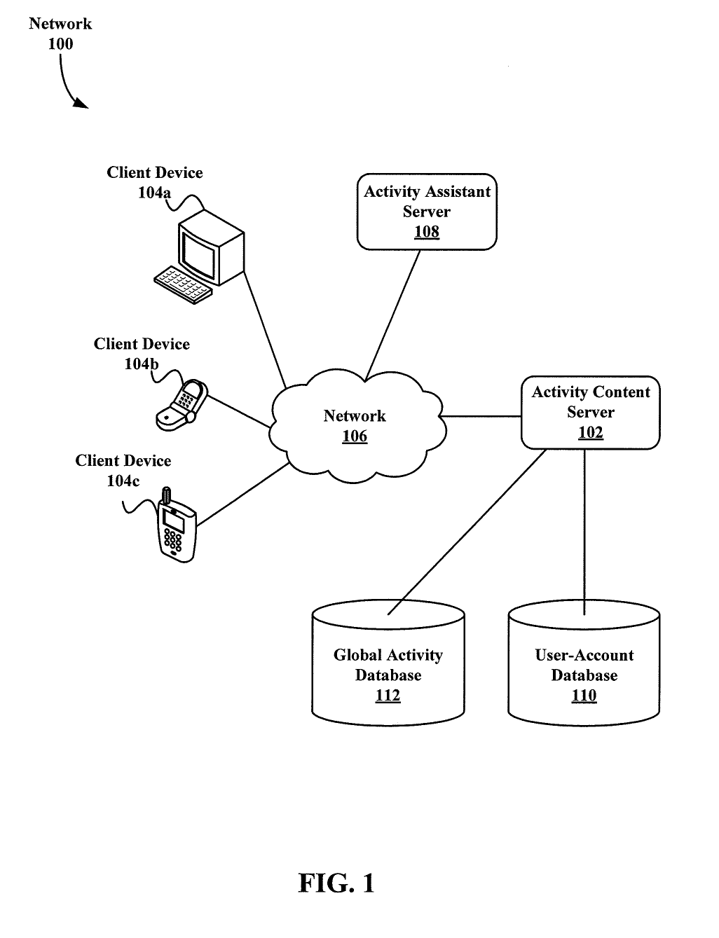

Turning to the figures, FIG. 1 depicts a network in accordance with an example embodiment. In network 100, activity assistant server 108 and possibly activity content server 102 are configured to communicate, via a network 106, with client devices 104a, 104b, and 104c. As shown in FIG. 1, client devices can include a personal computer 104a, a telephone 104b, and a smart-phone 104c. More generally, the client devices 104a, 104b, and 104c (or any additional client devices) can be any sort of computing device, such as an ordinary laptop computer, desktop computer, network terminal, wireless communication device (e.g., a cell phone or smart phone), and so on.

The network 106 can correspond to a local area network, a wide area network, a corporate intranet, the public Internet, combinations thereof, or any other type of network(s) configured to provide communication between networked computing devices. Activity content server 102 can provide content to client device 104a-104c and/or activity assistant server 108. The content can include, but is not limited to, web pages, hypertext, scripts, binary data such as compiled software, images, audio, and/or video. The content can include compressed and/or uncompressed content and/or encrypted and/or unencrypted content. Other types of content are possible as well.

In an alternative arrangement, activity assistant server 108 and activity content server 102 can be co-located and/or combined as a common server. Further, it also possible that activity assistant server 108 and/or activity content server 102 can be accessible via a network separate from the network 106. Yet further, although FIG. 1 only shows three client devices, activity assistant server 108 and/or activity content server 102 can serve any number of client devices (from a single client device to hundreds, thousands, or even more client devices).

Global activity database 112 typically includes activity data that defines a plurality of activities. In particular, the activity data for each activity may include one or more global activity parameters that collectively define the global context for the activity. Further, user-account database 110 may include per-account data for users' activity accounts. This per-account data may include, for a given one of the accounts, data indicating user-specific parameters and signals. Further, for a given activity account, the per-account data may include an indication of which activities, if any, are associated with the account (e.g., the activities that a user has added to their activity list).

According to an example embodiment, activity assistant server 108 embodies the “activity assistant” and thus is configured to provide the activity-assistant functionality described herein. In particular, activity assistant server 108 may be configured to identify signals relating to the importance of a particular activity to a particular user (e.g., relating to a given user-activity pair), so that activities can be logically displayed to a user, suggested to a user, and/or searched for a user via an activity assistant user interface.

In some embodiments, activity-assistant functionality described herein may also be performed by software on the device such as, but not limited to, devices 104a, 104b, and 104c as shown in FIG. 1. For example, the client software running on the device such as, but not limited to, devices 104a, 104b, and 104c as shown in FIG. 1 may perform all or some portion of the ranking functionality and/or provide more advanced assistance, e.g. by providing a latitude/longitude and/or map for an address entered by the user via an activity assistant user interface and/or by directly communicating with an activity assistant processing system.

The activity assistant server 108 may acquire the data from which signals are determined, and/or data directly providing signals, from a number of different data sources. For example, activity content server 102 may provide activity assistant server 108 with access to global activity database 112 and user-account database 110. Thus, when evaluating the importance of a particular activity to a particular user, activity assistant server 108 may retrieve the global parameters of the activity from global activity database 112, as well as user-specific parameters from user-account database 110.

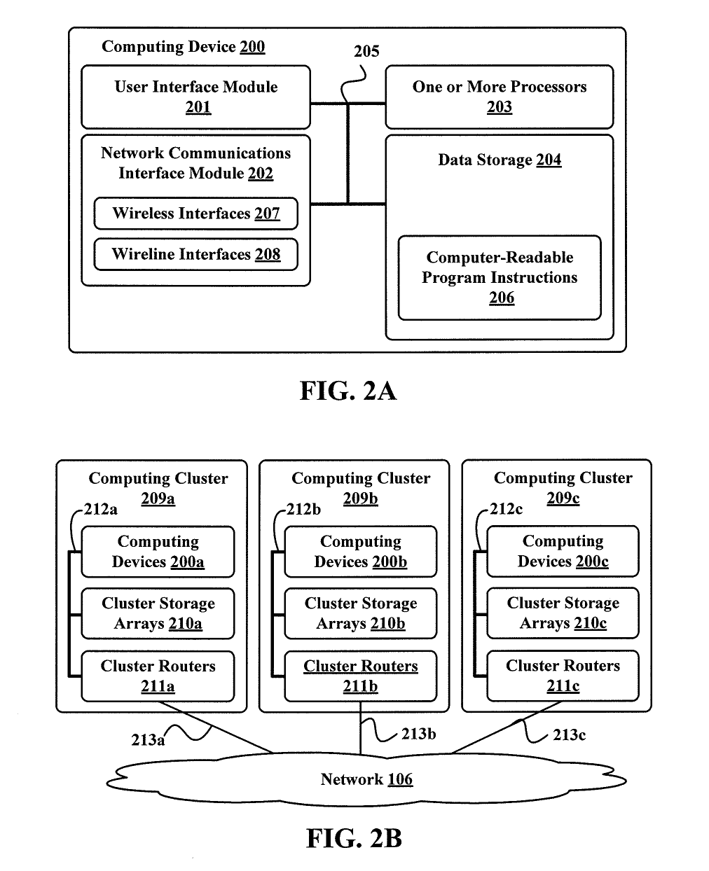

FIG. 2A is a block diagram of a computing device in accordance with an example embodiment. Computing device 200 can be configured to perform one or more functions of client devices 104a, 104b, and 104c, activity assistant server 108, and/or activity content server 102. The computing device 200 can include a user interface module 201, a network-communication interface module 202, one or more processors 203, and/or data storage 204, all of which can be linked together via a system bus, network, or other connection mechanism 205.

The user interface module 201 can be operable to send data to and/or receive data from external user input/output devices. For example, the user interface module 201 can be configured to send/receive data to/from user input devices such as a keyboard, a keypad, a touch screen, a computer mouse, a track ball, a joystick, a microphone, and/or other similar devices, now known or later developed. The user interface module 201 can also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, now known or later developed. The user interface module 201 can also be configured to receive audible input(s) via the microphone (or similar audio input device) and/or generate audible output(s), such as a speaker, speaker jack, audio output port, audio output device, earphones, and/or other similar devices, now known or later developed.

The network-communications interface module 202 can include one or more wireless interfaces 207 and/or wireline interfaces 208 that are configurable to communicate via a network, such as the network 106 shown in FIG. 1. The wireless interfaces 207 can include one or more wireless transceivers, such as a Bluetooth transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, and/or other types of wireless transceivers configurable to communicate via a wireless network. The wireline interfaces 208 can include one or more wireline transceivers, such as an Ethernet transceiver, a Universal Serial Bus (USB) transceiver, or similar transceiver configurable to communicate via a wire, a twisted pair of wires, a coaxial cable, an optical link, a fiber-optic link, or other physical connection to a wireline network.

In some embodiments, the network communications interface module 202 can be configured to provide reliable, secured, compressed, and/or authenticated communications. For each communication described herein, information for ensuring reliable communications (e.g., guaranteed message delivery) can be provided, perhaps as part of a message header and/or footer (e.g., packet/message sequencing information, encapsulation header(s) and/or footer(s), size/time information, and transmission verification information such as cyclic redundancy check (CRC) and/or parity check values). Communications can be compressed and decompressed using one or more compression and/or decompression algorithms and/or protocols such as, but not limited to, one or more lossless data compression algorithms and/or one or more lossy data compression algorithms. Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well or in addition to those listed herein to secure (and then decrypt/decode) communications.

The one or more processors 203 can include one or more general purpose processors and/or one or more special purpose processors (e.g., digital signal processors, application specific integrated circuits, etc.). The one or more processors 203 can be configured to execute computer-readable program instructions 206 that are contained in the data storage 204 and/or other instructions as described herein.

The data storage 204 can include one or more computer-readable storage media that can be read or accessed by at least one of the processors 203. The one or more computer-readable storage media can include volatile and/or non-volatile storage components, such as optical, magnetic, organic or other memory or disc storage, which can be integrated in whole or in part with at least one of the one or more processors 203. In some embodiments, the data storage 204 can be implemented using a single physical device (e.g., one optical, magnetic, organic or other memory or disc storage unit), while in other embodiments, the data storage 204 can be implemented using two or more physical devices.

Computer-readable storage media associated with data storage 204 and/or other computer-readable media described herein can also include non-transitory computer-readable media such as computer-readable media that stores data for short periods of time like register memory, processor cache, and random access memory (RAM). Computer-readable storage media associated with data storage 204 and/or other computer-readable media described herein can also include non-transitory computer readable media that stores program code and/or data for longer periods of time, such as secondary or persistent long term storage, like read only memory (ROM), optical or magnetic disks, compact-disc read only memory (CD-ROM), for example. Computer-readable storage media associated with data storage 204 and/or other computer-readable media described herein can also be any other volatile or non-volatile storage systems. Computer-readable storage media associated with data storage 204 and/or other computer-readable media described herein can be considered computer readable storage media for example, or a tangible storage device.

The data storage 204 can include computer-readable program instructions 206 and perhaps additional data. In some embodiments, the data storage 204 can additionally include storage required to perform at least part of the herein-described techniques, methods (e.g, methods 700 and 800), and/or at least part of the functionality of the herein-described devices and networks.

FIG. 2B depicts a network with computing clusters in accordance with an example embodiment. In FIG. 2B, functions of activity assistant server 108 and/or activity content server 110 can be distributed among three computing clusters 209a, 209b, and 208c. The computing cluster 209a can include one or more computing devices 200a, cluster storage arrays 210a, and cluster routers 211a connected by local cluster network 212a. Similarly, computing cluster 209b can include one or more computing devices 200b, cluster storage arrays 210b, and cluster routers 211b connected by local cluster network 212b. Likewise, computing cluster 209c can include one or more computing devices 200c, cluster storage arrays 210c, and cluster routers 211c connected by a local cluster network 212c.

In some embodiments, each of computing clusters 209a, 209b, and 209c can have an equal number of computing devices, an equal number of cluster storage arrays, and an equal number of cluster routers. In other embodiments, however, some or all of computing clusters 209a, 209b, and 209c can have different numbers of computing devices, different numbers of cluster storage arrays, and/or different numbers of cluster routers. The number of computing devices, cluster storage arrays, and cluster routers in each computing cluster can depend on the computing task or tasks assigned to each computing cluster.

In computing cluster 209a, for example, computing devices 200a can be configured to perform various computing tasks of activity content server 102. In one embodiment, the various functionalities of activity content server 102 can be distributed among one or more of the computing devices 200a. For example, some of these computing devices can be configured to provide part or all of a first set of content while the remaining computing devices can provide part or all of a second set of content. Still other computing devices of the computing cluster 209a can be configured to communicate with activity assistant server 108. Computing devices 200b and 200c in computing clusters 209b and 209c can be configured the same or similarly to the computing devices 200a in computing cluster 209a.

On the other hand, in some embodiments, computing devices 200a, 200b, and 200c each can be configured to perform different functions. For example, computing devices 200a and 200b can be configured to perform one or more functions of activity content server 102, and the computing devices 200c can be configured to perform one or more functions of activity assistant server 108.

Cluster storage arrays 210a, 210b, and 210c of computing clusters 209a, 209b, and 209c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of activity assistant server 108 and/or activity content server 102 can be distributed across computing devices 200a, 200b, and 200c of respective computing clusters 209a, 209b, and 209c, various active portions and/or backup/redundant portions of these components can be distributed across cluster storage arrays 210a, 210b, and 210c. For example, some cluster storage arrays can be configured to store data for activity assistant server 108, while other cluster storage arrays can store data for activity content server 102. Additionally, some cluster storage arrays can be configured to store backup versions of data stored in other cluster storage arrays.

The cluster routers 211a, 211b, and 211c in the computing clusters 209a, 209b, and 209c can include networking equipment configured to provide internal and external communications for the computing clusters. For example, the cluster routers 211a in the computing cluster 209a can include one or more internet switching and/or routing devices configured to provide (i) local area network communications between the computing devices 200a and the cluster storage arrays 201a via the local cluster network 212a, and/or (ii) wide area network communications between the computing cluster 209a and the computing clusters 209b and 209c via the wide area network connection 213a to the network 106. The cluster routers 211b and 211c can include network equipment similar to the cluster routers 211a, and the cluster routers 211b and 211c can perform similar networking functions for the computing clusters 209b and 209b that the cluster routers 211a perform for the computing cluster 209a.

In some embodiments, computing tasks and stored data associated with activity assistant server 108 and/or activity content server 102 can be distributed across the computing devices 200a, 200b, and 200c based at least in part on the processing requirements for functions of activity assistant server 108 and/or user account server 102, the processing capabilities of the computing devices 200a, 200b, and 200c, the latency of the local cluster networks 212a, 212b, and 212c and/or of the wide area network connections 213a, 213b, and 213c, and/or other factors that can contribute to the cost, speed, fault-tolerance, resiliency, efficiency, and/or other design goals of the overall system architecture.

Additionally, the configuration of the cluster routers 211a, 211b, and 211c can be based at least in part on the data communication requirements of the computing devices and cluster storage arrays, the data communications capabilities of the network equipment in the cluster routers 211a, 211b, and 211c, the latency and throughput of the local cluster networks 212a, 212b, 212c, the latency, throughput, and cost of the wide area network connections 213a, 213b, and 213c, and/or other factors that can contribute to the cost, speed, fault-tolerance, resiliency, efficiency and/or other design goals of the system architecture.

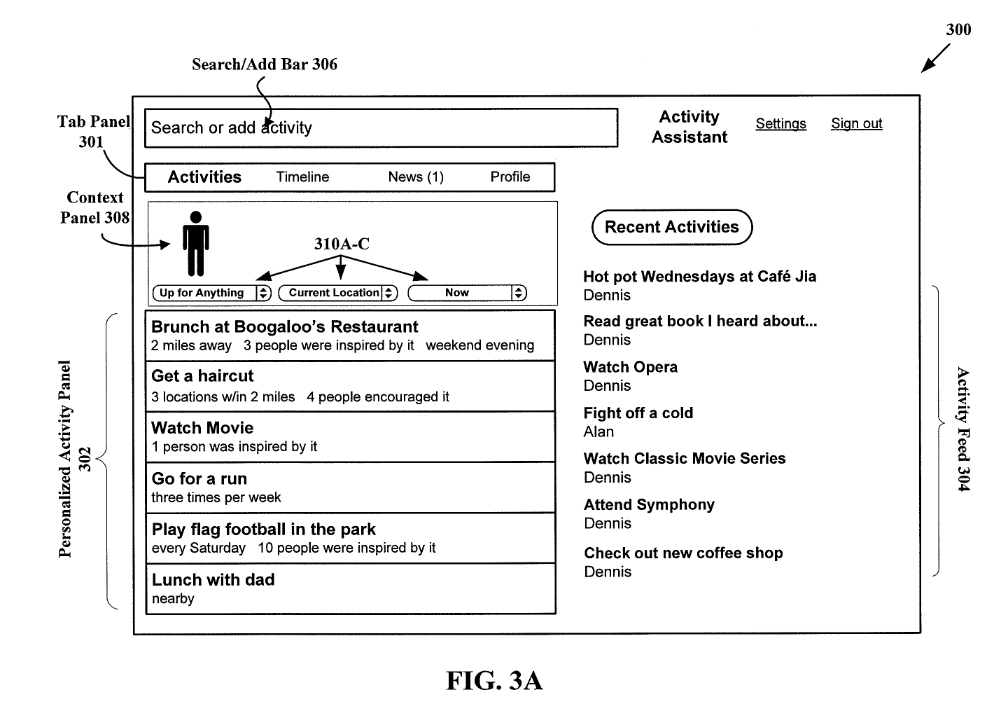

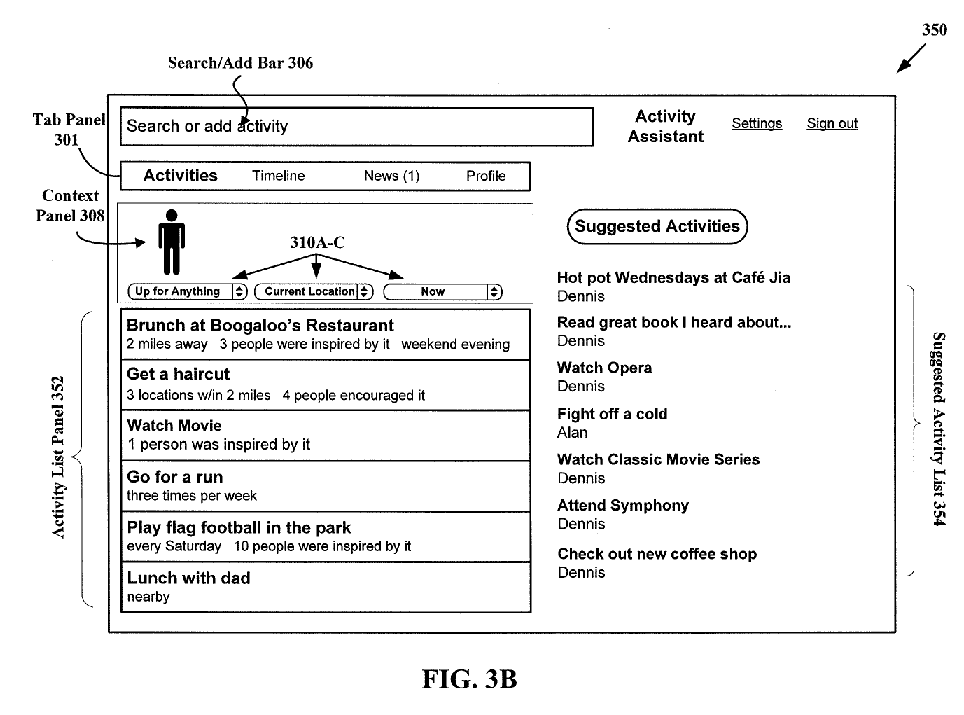

FIG. 3A is a block diagram illustrating features of a user interface, according to an example embodiment. In particular, activity-assistant user interface 300 may be displayed via a client device once a user has logged in to their activity-assistant account, and may allow a user to interact with an activity assistant. While only one screen of the activity-assistant user interface 300 is shown, it should be understood that the activity-assistant user interface may include other screens, which provide additional functionality, without departing from the scope of the invention. As shown, activity-assistant user interface 300 includes a personalized activity panel 302, an activity feed 304 that displays activities that have been added, done, and/or recently updated by friends of the user (or members of the user's social graph and/or social network), a search/add bar 306, and a context panel 308. Further, context panel 308 includes a number of input mechanisms 310 A-C via which a user can input context signals.

The context panel 308 provides an interactive mechanism for users to provide context signal data that describes a “user context” (e.g. to provide signals indicative of the user's intent, interest, mood, state-of-mind, experience, perception, associations with other users, etc.). In the illustrated example, input mechanism 310A on the left of context panel 308 allows a user to signal their mood (e.g., “up for anything”, “lazy”, “productive”, “social”, etc.). The input mechanism 310B in the center of context panel 308 allows a user to signal a location (e.g., “current location”, “home”, “work”, “stadium”, etc.). Further, input mechanism 310C on the right of context panel 308 allows a user to signal a time or timeframe (e.g., “now”, “tomorrow”, “tonight”, “next Wednesday morning”, “2:00 AM CST”, “9:00 PM EST on Saturday”, etc.). Other input mechanisms are possible as well.

While the context information provided via the input mechanisms of the context panel 308 may be referred to as “signals” from the user, it should be understood that, programmatically, this information may take the form of user-specific parameters that are associated with the user's activity account. As such, the data provided via input mechanisms 310 A-C may be stored in a user-account database. For example, referring back to FIG. 1, data from input mechanisms 310 A-C may be stored as user-specific parameters in user-account database 110. It is also possible that activity assistant server 108 may be fed data or may pull data directly from input mechanisms 310 in real-time.

The context signal data acquired from the context panel 308 (e.g., user-specific parameters related to “user context”) may be combined by the activity assistant (e.g., activity-assistant server 108 and/or activity content server 102) with global parameters of a given activity, other user-specific parameters, and/or data from other sources, in order to derive signals indicative of activity-importance of the given activity to the user. In this context, the “signals” are the information relative to the importance of the activity that is derived from the data (e.g., the user-specific parameters, global parameters, etc.). As such, the activity assistant may interpret a user-parameter as a signal in and of itself.

For instance, the user's mood (provided via input mechanism 310A) may be interpreted as a signal that makes any number of activities more or less important for the user. As a specific example, if the user's mood is “lazy”, the activity “watching a movie” may become more important than it otherwise would be (as global parameters may indicate that “lazy” is a mood associated with the “watching a movie” activity). On the other hand, the activity “go to the gym” may become less important than it otherwise would be (as global parameters of “watching a movie” do not typically include “lazy” as an associated mood, or may in fact indicate that “lazy” is a mood that is likely incompatible with this activity).

The activity assistant may also derive more complex signals by evaluating the relationships and/or interactions between user-specific parameters, global parameters, and/or other data items. To provide an example, a user may have provided a “love being outdoors” signal, which may be stored in the user's account as a user-specific parameter (note that a user interface input mechanism not shown on the screen 300, but is contemplated as being available). At a given point in time, the user also may have set their mood to “active” via input mechanism 310A, set their location to “current location” via input mechanism 310B, and set their time to “tomorrow afternoon”. The activity assistant may interpret this data as including a signal that the user would like to do something active tomorrow afternoon at the same place they are currently located.

Further, the activity assistant may use other data sources to determine other relevant signals, such as the weather forecast for the next day at the user's current location or the location that the user will likely be at the next day. Tomorrow afternoon's weather forecast may thus be a signal, which can be combined with the signal derived from the user-specific parameters to provide a more-refined signal that, for example, outdoor fitness or sporting activities near the user's location should always be favored over indoor fitness or sporting activities near the user's location, unless the tomorrow afternoon's forecast is for rain, in which case the amount by which outdoor activities are favored over indoor activities may be reduced (or indoor activities may actually be favored). For instance, combining all of this information, the activity assistant may increase the importance of active outdoor activities (e.g., “go for a run”, “play flag football”, etc.) to a greater extent when the forecast is for sunny weather, than when the forecast is for rain or snow.

The activity assistant may apply signal-based techniques, such as those described herein, to assess activity-importance for a number of activities and the importance of these activities relative to one another. This technique may be employed to provide the user with various functions that are tailored to the user's context.

For example, personalized activity panel 302 may display intelligently selected and ordered activities from a pool of activities including the activities a user has added to their account and suggested activities that have been selected for a user. For example, a number of suggested activities may be determined based on factors such as user preferences, signals from the context panel, global parameters of potential activities, activities that have been added and/or done by friends of the user, and/or activities that have been added and/or done by the user in the past, among others. These suggested activities may then be combined with the activities a user has already added to create a pool of potential activities for the personalized activity panel 302. Then, to determine which specific activities to display in personalized activity panel 302, the activity assistant may quantify the importance of each activity (e.g., by evaluating signals for each activity), so that the activities that are most important to the user are displayed.

Note that personalized activity panel 302 may visually differentiate between activities that a user has already added to their account, and suggested activities. For example, the “Watch Movie” activity is displayed with a dark background and white text to indicate that it is a suggested activity (and that the user may thus wish to add it), whereas the other activities listed in personalized activity panel 302 all have a white background with black text, thus indicating that the user has already added these activities.

Further, the evaluation of importance may also be applied in the process of determining which activities should be displayed in the activity feed 304 (and possibly the order in which those activities are displayed). In particular, a certain number of the most recently-added and updated activities may be evaluated based on signals such as those described above, and the most important of the recent activities may be displayed (possibly in the order of importance. Alternatively, it should be understood that activity feed 304 may simply display activities in a time-wise manner as they are added/updated/completed, without adjusting based on the user's context. In a similar manner, search results (not shown) for an activity search via search/add bar 306 may be displayed based at least in part on importance of the activities located in the search, or may simply be displayed in an order according to one of the many well-known search techniques.

FIG. 3B is another block diagram illustrating features of a user interface, according to an example embodiment. In particular, FIG. 3B illustrates an alternative activity-assistant user interface 350, which may be displayed via a client device once a user has logged in to their activity-assistant account. Activity-assistant user interface 350 includes some of the same UI elements as activity-assistant user interface 300 of FIG. 3A (e.g., search/add bar 306 and context panel 308 including a number of input mechanisms 310 A-C). However, activity-assistant user interface 350 includes an activity list 352 and a suggested activity list 354.

In this embodiment, activity list 352 may include only activities that a user has added to their account. Thus, by evaluating signals for each activity a user has added to their account, the activity assistant can determine which activities should be displayed in activity list 352 (and the order in which those activities should be displayed).

Furthermore, suggested activity list 354 may display only suggested activities (which have not yet been added by the user.) Accordingly, the importance of specific activities may also be a factor in the process of determining which activities should be displayed in the suggested activity list 354 (and the order of those activities).

In a further aspect, certain features of the activity-assistant UI may display activities that have not yet been added by a user, but have been added by another user that is associated with the user in some manner (e.g., a friend or associate of the user who is logged in), and may provide the user with the option to add these activities to their activity list (or more generally, to associate these activities with their account. For example, the pool of suggested activities from which some of the activities for personalized activity panel 302 of FIG. 3A may be selected, may include some or all the activity lists of a user's “friends” (i.e., other users that the user has associated with in some manner). As another example, activities listed in activity feed 304 are often listed because a friend has added, done, or taken some action related to the activity. Thus, some or possibly all suggested activities on the list may be linked to the corresponding friend. Therefore, as shown in the example, the activities shown in suggested activity feed 304 each identify another user (i.e., the user's friend) who has already added the activity to their activity list.

Further, the suggested activity list 354 of FIG. 3B may function in a similar manner with respect to listing friends associated with the listed activities (except that it may only include suggested activities, wherein personalized activity panel 302 may include a user's added activities and suggested activities). In particular, an example suggested activity list 354 may include a number of UI elements, each listing an activity, and if any of the user's friend have added the activity the name (or names) of the friend (or friends) that have already added the activity. For example, in suggested activity list 354, the UI element for the “Watch Classic Movie Series” activity indicates that the user “Dennis” has already added the account. Thus, when a user interacts with this UI element, the user may be provided the option to add the activity to their activity list (or alternatively, interacting with this element may automatically add the activity).

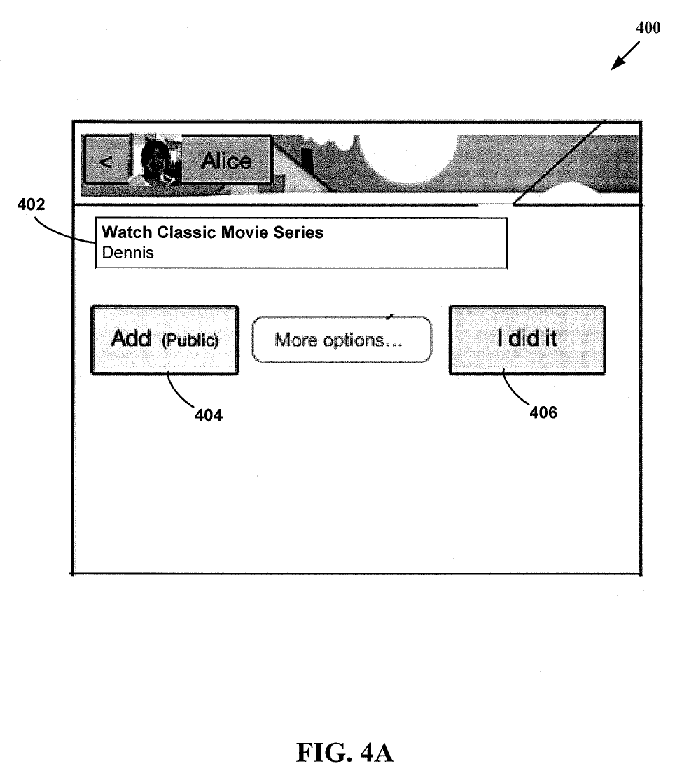

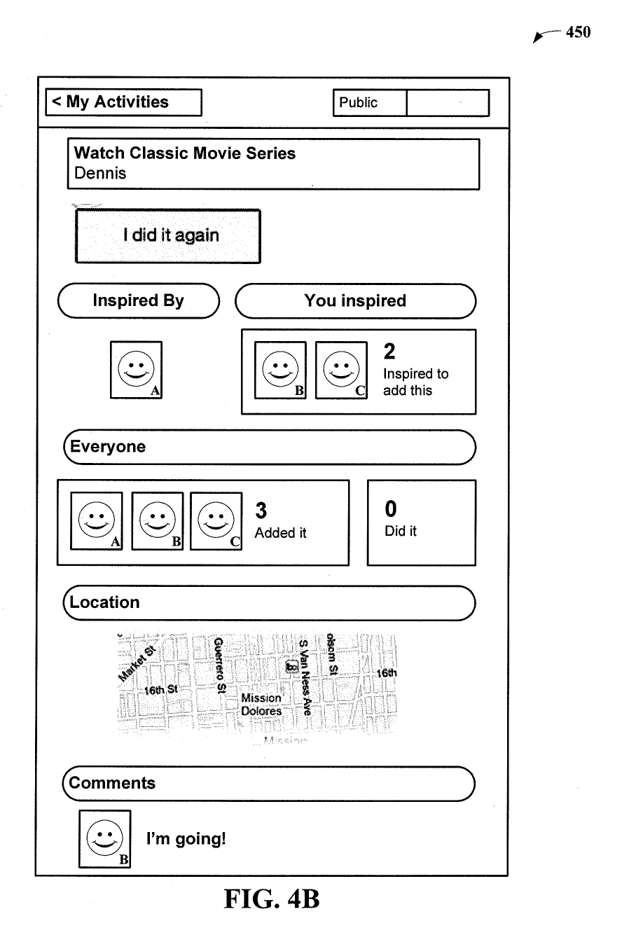

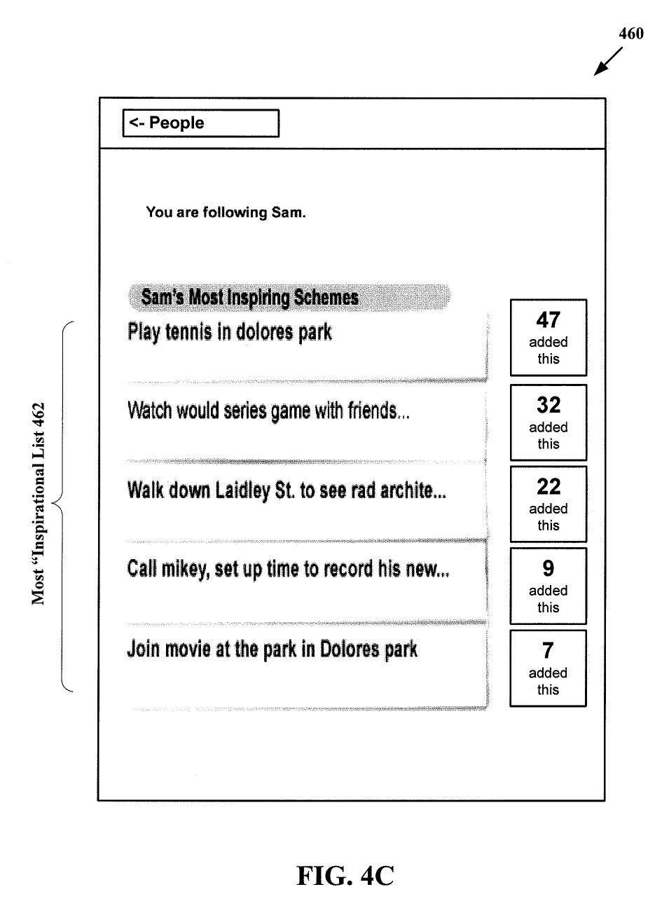

FIG. 4A is an illustration of a UI to add an activity, according to an example embodiment. UI 400 may be accessed when a user (e.g., “Alice”) interacts with (e.g., clicks on) the UI element of a given activity 402 (e.g., “Watch Classic Movie Series”) in suggested activity list 354. UI 400 includes an “Add” UI element 404 and an “I did it” UI element 406, which are clickable “button” elements in the illustrated example. The user may accordingly interact with (e.g., click on) Add button 404 to add the activity to their activity list. Alternatively, the user may interact with (e.g., click on) “I did it” button 404 to add the activity to their activity list, and also store data indicating that the user has in fact completed the activity.

In a further aspect, certain elements of the activity-assistant UI may be provided to help users derive satisfaction from recommending activities to other users by visualizing which activities they've inspired others to engage in. For instance, UI elements in the user's activity list 302 may indicate, for a given activity, how many and/or which specific other users have been “inspired” by the user to add and/or complete an activity. A given user may be considered to have been “inspired” by another user, when the adding and/or completing of the activity is associated with the other user (i.e., by adding and/or completing an activity via a suggested activity-list UI element that indicates a friend has already added the activity). Such functionality may help motivate users to add high quality activities to their account, as well as to share new and existing activities with friends who will be interested in them and actually do them. For example, in activity list 302, the UI element for the “Watch harry potter movie” activity indicates that five people were inspired by it, and of these five people, three actually “did it” (e.g., completed or did the activity by watching the movie).

In a further aspect, activity assistant UI 300 may allow a user to interact with a UI element for an activity in activity list 302, and responsively provide a more detailed UI for the activity. FIG. 4B is an illustration of a UI including activity detail, according to an example embodiment. In particular, UI 450 is an activity detail UI that may be displayed when a user interacts with a UI element for an activity on their activity list 302. UI 450 shows various pieces of information relating to the sharing of the “Watch Classic Movie Series” activity between users. In particular, it shows who the user was inspired by (i.e., user A), how many other users the user has inspired to add the activity (i.e., two users), and an “avatar” for some or all of the users the other users who were inspired (i.e., users B and C). Further, UI 450 shows how many other users have added the activity in total (i.e., three users) and avatars for some or all other users that have added the activity (i.e., users, A, B and C). UI 450 may also provide the location of the activity, and comments from users who have added the activity.

In practice, activity assistant server 108 may process user interactions with the activity-assistant UI, and maintain data in user-account database 110 that indicates, for a given user-account, how many people have been “inspired” to add and/or complete a given activity on the user's activity list (and possibly which specific users have added and/or completed the given activity). This data may take the form of user-specific parameters stored in user-account database 110. Further, this data may be interpreted by the activity assistant as providing signals as to the importance of a given activity to the user. For example, activities that have inspired more people may be considered more important, and activities that have actually been done by more people may be considered even more important.

The activity assistant may use data from user-account database 110 relating to how many people have been “inspired” to add and/or complete a given activity, possibly depending upon the various privacy settings of the associated users, in order to provide various types of interactive functions that enhance the user experience. For example, a UI may be provided that allows users to view one another's “profiles.” A user's profile may accordingly display a list of a user's most “inspirational” activities (i.e., the activities that the user has “inspired” the greatest number of other users to add and/or do) to other users viewing the profile.

FIG. 4C is an illustration of a UI displaying a list of a user's most “inspirational” activities, according to an example embodiment. This UI 460 includes a most “inspirational” list 462. As shown, the display for the list 462 includes an “add count” associated with each activity (e.g., the add-count is “47” for the “Play tennis in dolores park” activity), and is ordered according to descending add-count, Furthermore, in the illustrated example, this UI is being displayed to another user who is “following” Sam (i.e., who has previously indicated in some manner that Sam is a user they wish to be associated with their user account). Providing a most “inspirational” list 462 may inspire a user viewing Sam's profile to add an activity from the list to their own account, and/or to do (i.e., complete) the activity. However, such a screen could also be displayed to Sam via a UI accessed from his account profile, or to another user who is not “following” Sam.

In a further aspect, the activity assistant may compile “inspiration data” indicating: (a) the total number of times that a given user has “inspired” another user to add any activity from the given user's activity list, and/or (b) the total number of times that the given user has “inspired” another user to do (i.e., complete) any activity from the given user's activity list. Depending upon the various users' privacy settings, this data may then be used to, for a given user, display a list of the other users that have inspired the given user to add and/or do the greatest number of activities.

This “inspiration data” may be used for various other purposes as well. As one example, the activity assistant may provide a global leaderboard ranking users according to who has inspired the most activity adds and/or the most activity completions. This global leaderboard may be referred to as a “most inspiring people” leaderboard, and may be presented via a UI 460 in a similar manner as the most “inspirational” list 462 of FIG. 4C, except that the display may include, for each listed activity, an indication of the user who has inspired the number of users qualifying the activity for the leaderboard. In a similar manner “most inspiring people” leaderboards may be created within certain groups of users. For example, the activity assistant may generate a “most inspiring people” leaderboard within a certain geographical area (e.g., “in San Francisco, Calif.”), within a certain defined social group (e.g., within a user's friends, family, and/or friends of friends), within an online social network or group established within the online social network, or within a topic area (e.g., users with the most inspiring schemes about babies, gardening, or baseball, for instance).

In some embodiments, features such as the above that involve (a) the ranking of users based on how many other users they have inspired and/or (b) the ranking of activities based on how many other users a given user has inspired, may involve activities that have just been added by others, as well as activities that others have added and done (i.e., completed). In such embodiments, inspiring another user to complete an activity might be weighted differently (e.g., weighted more heavily), than merely inspiring the other user to add the activity.

In a yet a further aspect, the activity assistant may determine that a signal exists that indicates a certain activity is more “ambitious” (i.e., more difficult to complete) than other activities. For example, the activity assistant may determine an “add/complete” from a global parameter indicating how many users have added an activity and another global parameter indicating, of those users, how many have completed the activity. A higher add/complete ratio indicates that a lower percentage of users (who have added a certain activity) actually go on to complete the activity. Thus, a higher add/complete ratio may be interpreted as a signal that an activity is more “ambitious” than an activity with a lower add/complete ratio.

As another example of the use of “inspiration data” in practice, it may be used to derive a signal that is indicative of a user's “reputation.” For example, data indicating how many other user's a given user has inspired may be interpreted as a signal that is indicative, alone or in combination with other data, of the user's propensity to add quality activities, and thus of the user's “reputation.” Such a signal may be utilized in a number of functions, such as spam filtering (e.g., comments on highly visible activities from lower-reputation users might be routed to a human moderator before being made available publicly, while comments from higher-reputation users would immediately be made publicly-available). As another example, “push” or “alert” notifications when a user interacts with another user's activities and/or profile may vary according to reputation. For instance, when another user comments on a given user's activity, the given user may only get a “push” or “alert” notification the commenting user is a friend of the given user. However, when a non-friend user with an especially high reputation comments on one of their activity of interest, this may also be grounds for sending the given user a notification. These examples are merely illustrative, as a reputation signal may be used in numerous other ways as well.

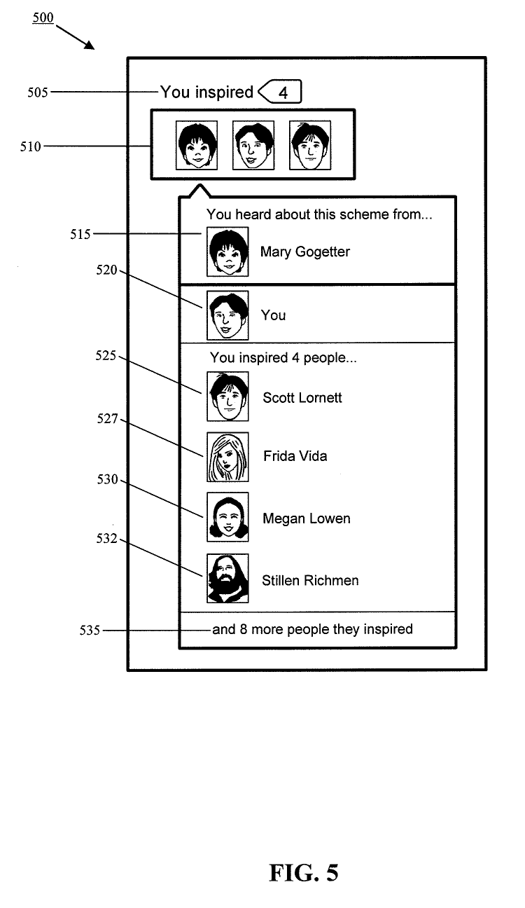

FIG. 5 is an illustration of a UI 500 displaying a list of users that are directly and indirectly inspired to add an activity, according to an example embodiment. The example UI 500 includes a display area 510 with one or more graphical representations (e.g., profile photo, icon, avatar, etc.) of different users. As further shown, the UI 500 includes an indication 505 of a number of users that are inspired by a current user 520. In one example, the current user 520 can get credit for inspiring another user(s) to add an activity based on 1) direct inspiration, and 2) indirect inspiration. For instance, direct inspiration involves the current user finding out about an activity from a first user who has added the activity (e.g., the first user wants to do the activity). In the case of indirect inspiration, the current user finds out about an activity from a second user who found out about the activity from the first user, and the current user wants to do the activity (e.g., by adding the activity). In both of the aforementioned cases of direct or indirect inspiration, the first user does not need to want to do the activity and the first user can inspire another user(s) to add an activity even if the first user does not want to do the activity (e.g., by not adding the activity).

As illustrated in the example UI 500, the current user 520 has found out about a scheme (e.g., an activity) from a user 515 (corresponding to a user with a name “Mary Gogetter”). The UI 500 includes the indication 505 that shows four different users are directly inspired by the current user 520. In particular, the example UI 500 includes users 525, 527, 530, and 532 that include respective graphical representations of each of the users 525, 527, 530, and 532. Further, the UI 500 includes an indication 535 that 8 additional users found out about the scheme indirectly from the current user 520.

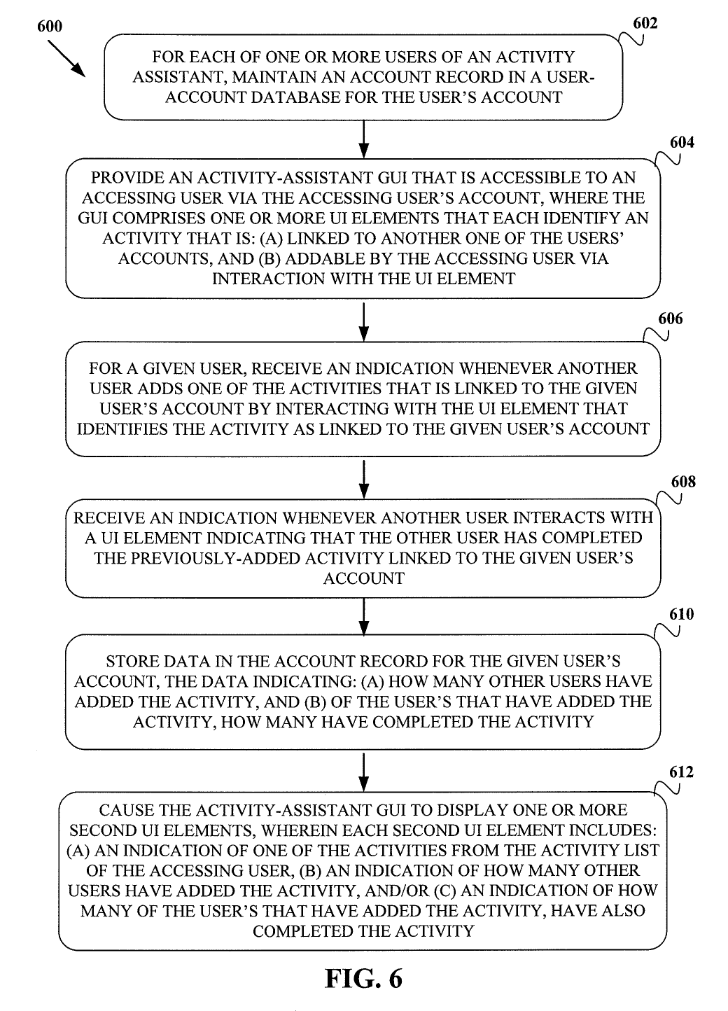

FIG. 6 is flow chart illustrating a method according to an example embodiment. In particular, method 600 may be carried out by an activity assistant in order to facilitate dynamic and flexible and activities. For example, activity assistant server 108 and/or user account server 102 of FIG. 1 may carry out a method such as method 600 to facilitate dynamic user interaction with activities via an interface such as the activity-assistant user interfaces of FIGS. 3A and 3B.

More specifically, method 600 involves the activity assistant, for each of one or more users of an activity assistant, maintaining an account record in a user-account database for the user's account, as shown by block 602. In an example embodiment, the account record specifies an activity list including one or more activities associated with the user's account. Further, the activity assistant provides an activity-assistant GUI that is accessible to an accessing user via the accessing user's account, where the GUI comprises one or more UI elements that each identify an activity that is: (a) linked to another one of the users' accounts, and (b) addable by the accessing user via interaction with the UI element, as shown by block 604. Then, for any given user, the activity assistant may receive an indication (e.g., via a notification message) whenever another user adds one of the activities that is linked to the given user's account by interacting with the UI element that identifies the activity as linked to the given user's account, as shown by block 606. Further, the activity assistant may receive an indication (e.g., via a notification message) whenever another user interacts with a UI element indicating that the other user has completed the previously-added activity linked to the given user's account, as shown by block 608.

Other types of notification messages or indications can be provided to the given user and still be within the scope of the subject technology. By way of example, a notification message responsive to another user adding the given user's activity can be filtered so that the given user only gets notified when the user's friend(s) has added an activity (e.g., in the case that the user does not wish to be notified when a non-friend user(s) has added the activity). In other words, a notification message is only sent if the other users are considered friends of the user. Further, a notification message can be sent to respond to a given activity surpassing a predetermined inspiration threshold (e.g., when a certain number of other users have added the given user's activity). In one example, the inspiration threshold is a metric that measures a number of users that have added the given user's activity (“inspirations”). For instance, one type of notification message is sent to the given user based on round numbers that are divisible by 1, 2 and 5 (e.g., starting with 5 inspirations, then 10, 20, 50, 100, 200, 500, etc.). Another notification message is sent to the given user responsive to the user's overall number of inspirations (e.g., when a certain number of other users have added the given user's activity) surpassing a certain number (e.g., “Congratulations! Your activities have now inspired people over 1000 times.”).

In addition to the above notifications and indications, the subject technology provides a visual or textual indicator of the given user's status as measured by the user's overall number of inspirations as described above. The number of inspirations, in some examples, is a metric that metric for the given user that tracks a number of users that add and/or perform (e.g., “done”) an activity of the given user. The given user's status can be expressed in a description of the user in one example. For instance, the visual or textual indicator can be expressed as a message that states, “You are now Diabolical! Inspire 35 more people to be Fiendish.” Other types of visual or textual indicators can be included and still be within the scope of the subject technology. In one example, a badge or graphical representation is provided on the given user's profile, which would be publicly visible to display the user's status.

In a further aspect of method 600, the activity assistant may store data in the account record for the given user's account, the data indicating: (a) how many other users have added the activity, and (b) of the users that have added the activity, how many have completed the activity. As such, the activity assistant may then cause the activity-assistant GUI to display one or more second UI elements, wherein each second UI element includes: (a) an indication of one of the activities from the activity list of the accessing user, (b) an indication of how many other users have added the activity, and/or (c) an indication of how many of the user's that have added the activity, have also completed the activity.

With respect to any or all of the block diagrams and flow charts in the figures as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or message may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

It should be understood that for situations in which the systems and methods discussed herein collect personal information about users, the users may be provided with an opportunity to opt in/out of programs or features that may collect personal information (e.g., information about a user's preferences or a user's contributions to social content providers). In addition, certain data may be anonymized in one or more ways before it is stored or used, so that personally identifiable information is removed. For example, a user's identity may be anonymized so that the no personally identifiable information can be determined for the user and so that any identified user preferences or user interactions are generalized (for example, generalized based on user demographics) rather than associated with a particular user.

While various aspects and embodiments have been disclosed herein, other aspects and embodiments will be apparent to those skilled in the art. The various aspects and embodiments disclosed herein are for purposes of illustration and are not intended to be limiting.

1. A method performed by a computing device, the method comprising:
maintaining an account record in a user-account database for a first user's account, wherein the account record comprises an activity list comprising one or more activities linked to the first user's account;
providing for display an activity-assistant graphical user interface (GUI), wherein the activity-assistant GUI comprises one or more activity-related user-interface (UI) elements that each identify a respective activity that is: (a) linked to the first user's account based on the first user's account record, and (b) addable by an accessing user via interaction with an associated activity-related UI element;
storing a first set of data in the account record for the first user's account, wherein the first set of data includes: (a) a number of first accessing users that have added a first activity of the one or more activities based on the first activity being linked to the first user's account, (b) a number of second accessing users that have added the first activity based on the first activity being linked to a user account of one of the first accessing users, (c) of the first accessing users that have added the first activity, a number of the first accessing users that have completed the first activity, and (d) a first indication that the first activity was added to the activity list of the first user based on the first activity being linked to a user account of another user;
providing, for the first user's account, a notification message indicating that one of the second accessing users has added the first activity; and
providing for display a context UI associated with the first user, the context UI comprising:
a first UI element indicating a mood of the first user, the mood comprising information that is utilized to derive a signal indicative of an importance of an activity to the first user, wherein the activity is related to physical activity at a different location from the first user.

2. The method of claim 1, further comprising:
providing for display an activity-addition UI element and an activity-completion UI element based on detecting interaction with a first activity-related UI element of the one or more activity-related UI elements, the first activity-related UI element being associated with the first activity.

3. The method of claim 2, further comprising:
receiving a second indication to add the first activity to the activity list of the first user when interaction with the activity-addition UI element is detected; and
receiving a third-indication when interaction with the activity-completion UI element is detected, the third indication indicating that the accessing user has completed the first activity.

4. The method of claim 3, further comprising:
storing a second set of data in the account record for the first user's account when at least one of the second indication or the third indication is received.

5. The method of claim 1, further comprising:
causing the activity-assistant GUI to display one or more second UI elements, wherein the one or more second UI elements comprise a second indication of the first activity from the activity list of the accessing user.

6. The method of claim 5, wherein the one or more second UI elements further comprise a third indication of how many users have added the first activity from the activity list of the accessing user.

7. The method of claim 6, wherein the one or more second UI elements further comprise a fourth indication of how many of the users that have added the first activity from the activity list of the accessing user, have also completed the first activity from the activity list of the accessing user.

8. The method of claim 5, wherein causing the activity-assistant-GUI to display the one or more second UI elements is responsive to user input selecting the first activity from the activity list of the accessing user.

9. The method of claim 5, wherein the one or more second UI elements further comprise a location of the first activity from the activity list of the accessing user.

10. The method of claim 5, wherein the one or more second UI elements further comprise one or more comments for the first activity from the activity list of the accessing user.

11. The method of claim 10, wherein the one or more comments are respectively from one or more users that have added the first activity from the activity list of the accessing user.

12. The method of claim 11, further comprising:
transmitting a notification message to the accessing user responsive to the one or more users providing the one or more comments, wherein the notification message is only transmitted if the one or more users are considered friends of the accessing user.

13. The method of claim 1, further comprising:
causing the activity-assistant GUI to display one or more third UI elements, wherein the one or more third UI elements comprise a ranking of a set of activities based on a respective number of users that added each activity of the set of activities.

14. The method of claim 13, wherein the one or more third UI elements include respective UI elements for each activity of the ranked set of activities based on the respective number of users that added each activity of the ranked set of activities.

15. The method of claim 13, wherein the ranked set of activities is sorted in descending order.

16. A system comprising:
memory;
one or more processors configured at least to:
maintain an account record in a user-account database for a first user's account, wherein the account record comprises an activity list comprising one or more activities associated with the first user's account;
provide for display an activity-assistant graphical user interface (GUI), wherein the activity-assistant GUI comprises one or more activity-related user-interface (UI) elements that each identify a respective activity that is: (a) linked to the first user's account based on the first user's account record, and (b) addable by an accessing user via interaction with an associated activity-related UI element;
store a first set of data in the account record for the first user's account, wherein the first set of data includes: (a) a number of first accessing users that have added a first activity of the one or more activities based on the first activity being linked to the first user's account, (b) a number of second accessing users that have added the first activity based on the first activity being linked to a user account of one of the first accessing users, (c) of the first accessing users that have added the first activity, a number of the first accessing users that have completed the first activity, and (d) a first indication that the first activity was added to the activity list of the first user based on the first activity being linked to a user account of another user;
cause the activity-assistant GUI to display one or more second UI elements, wherein the one or more second UI elements comprise a second indication of the first activity from the activity list of the accessing user; and
provide, for the first user's account, a notification message indicating that one of the second accessing users has added the first activity
provide for display a context UI associated with the first user, the context UI comprising:
a first UI element indicating a mood of the first user, the mood comprising information that is utilized to derive a signal indicative of an importance of an activity to the first user, wherein the activity is related to physical activity at a different location from the first user.

17. The system of claim 16, wherein the one or more processors are further configured to:
receive a third indication when the accessing user adds one of the one or more activities that is linked to the first user's account via interaction with an activity-addition UI element that identifies the one of the one or more activities as linked to the first user's account.

18. The system of claim 17, wherein the one or more processors are further configured to:
receive a fourth indication when the accessing user interacts with an activity-completion UI element indicating that the accessing user has completed the one of the one or more activities that is linked to the first user's account.

19. The system of claim 18, wherein the one or more processors are further configured to:
store a second set of data in the account record for the first user's account when at least one of the third indication or the fourth indication is received.

20. An article of manufacture including a non-transitory computer-readable medium, having stored thereon program instructions that, upon execution by a computing device, cause the computing device to perform operations comprising:
maintaining an account record in a user-account database for a first user's account, wherein the account record comprises an activity list comprising one or more activities associated with the first user's account;
providing for display an activity-assistant graphical user interface (GUI), wherein the activity-assistant GUI comprises one or more activity-related user-interface (UI) elements that each identify an activity that is: (a) linked to the first user's account based on the first user's account record, and (b) addable by an accessing user via interaction with an associated activity-related UI element;
detecting interaction of the accessing user with a first activity-related UI element of the one or more activity-related UI elements, the first activity-related UI element being associated with a first activity linked to the first user's account;
providing for display an activity-addition UI element and an activity-completion UI element based on detecting interaction of the accessing user with the first activity-related UI element;
receiving a first indication to add the first activity to an activity list of the accessing user when interaction with the activity-addition UI element is detected;
receiving a second indication when interaction with the activity-completion UI element is detected, the second indication indicating that the accessing user has completed the first activity;
storing data in the account record for the first user's account when at least one of the first indication or the second indication is received, wherein the data includes: (a) a number of first accessing users that have added the first activity based on the first activity being linked to the first user's account, (b) a number of second accessing users that have added the first activity based on the first activity being linked to a user account of one of the first accessing users, (c) of the first accessing users that have added the first activity, a number of the first accessing users that have completed the first activity, and (d) a third indication that the first activity was added to the activity list of the first user based on the first activity being linked to a user account of another user;
providing, for the first user's account, a notification message indicating that one of the second accessing users has added the first activity; and
providing for display a context UI associated with the first user, the context UI comprising:
a first UI element indicating a mood of the first user, the mood comprising information that is utilized to derive a signal indicative of an importance of an activity to the first user, wherein the activity is related to physical activity at a different location from the first user.

21. The method of claim 2, further comprising:
receiving a second indication to add the first activity to the activity list of the first user when interaction with the activity-addition UI element is detected.

22. The method of claim 1, further comprising:
providing for display an activity detail UI associated with the first activity, the activity detail UI comprising:
a first particular UI element indicating a number of the first accessing users that have added the first activity based on the first activity being linked to the first user's account,
a second particular UI element indicating, of the number of the first accessing users that have added the first activity, a number of the first accessing users that have completed the first activity, and
a third particular UI element indicating the another user.

23. The method of claim 22, further comprising:
providing for display one or more second particular UI elements, wherein each of the one or more second UI elements is associated with one activity from the activity list of the first user; and
detecting interaction with one particular UI element of the one or more second particular UI elements, the one particular UI element being associated with the first activity, the providing for display the activity detail UI being in response to interaction with the one particular UI element.

24. The method of claim 1, wherein an activity parameter of the first activity for a first accessing user of the first accessing users is different from an activity parameter of the first activity for a second accessing user of the first accessing users.

25. The method of claim 24, wherein the activity parameter of the first activity for the first accessing user comprises a first day associated with performance of the first activity by the first accessing user, the activity parameter of the first activity for the second accessing user comprises a second day associated with performance of the first activity by the second accessing user, and the first day is different from the second day.

26. The method of claim 1, further comprising:
providing for display an inspiration UI associated with the first activity, the inspiration UI comprising:
a first particular UI element indicating a number of the first accessing users that have added the first activity based on the first activity being linked to the first user's account,
a second particular UI element indicating a number of the second accessing users that have added the first activity based on the first activity being linked to a user account of one of the first accessing users, and
a third particular UI element indicating the another user.

27. The method of claim 1, further comprising:
storing a second set of data in the account record for the first user's account, wherein the second set of data includes data indicating one or more moods of the first user, the one or more moods indicative of one or more activities being more or less important for the first user.

28. The method of claim 27, wherein the mood is associated with the activity and indicates that the activity is more important to the user.

29. The method of claim 27, wherein the mood indicates that the activity is incompatible with the mood based on the mood not being associated with the activity.

30. The method of claim 1, further comprising:
providing, for the first user's account, a second notification indicating that the number of second accessing users that have added the first activity surpasses a predetermined threshold.

31. The method of claim 1, further comprising:
providing, for the first user's account, a second notification indicating that the one of the second accessing users has completed the first activity.

32. The method of claim 1, wherein the signal indicative of the importance of the activity to the first user is based at least in part on a level of similarity between the mood of the first user and a respective mood related to the activity.
